(19) United States
(12) Patent Application Publication
(10) Pub. No.: US 2023/0119377 A1
(43) Pub. Date: Apr. 20, 2023

(54) Method for the Control of an Energy System, and Associated Device

(71) Applicant: Siemens Aktiengesellschaft, München (DE)

(72) Inventors: Sebastian Schreck, Nürnberg (DE); Sebastian Thiem, Neustadt an der Aisch (DE)

(73) Assignee: Siemens Aktiengesellschaft, München (DE)

(21) Appl. No.: 17/914,428

(22) PCT Filed: Dec. 11, 2020
(86) PCT No.: PCT/EP2020/085666

§ 371 Date: Sep. 26, 2022

(30) Foreign Application Priority Data
Mar. 25, 2020 (DE) 10 2020 203 853.8

(51) Int. Cl. G06Q 50/06; G06Q 10/0631; H02J 3/38

(52) U.S. Cl. CPC G06Q 50/06; G06Q 10/06315; H02J 3/381; H02J 2300/22; H02J 2300/28

(57) ABSTRACT

Various embodiments include methods for controlling energy conversion, energy storage, energy transportation, and/or energy consumption of multiple energy installations of an energy system and/or of multiple consumers flexible with regard to their load. The method may include: optimizing values of variables for control by calculation based on a first and a second optimization variable; calculating multiple solutions of the values optimum with regard to the first optimization variable, using a first optimization; ascertaining one of the calculated solutions as optimum with regard to the second optimization variable using a second optimization; and using the optimum calculated solution for controlling the energy system.

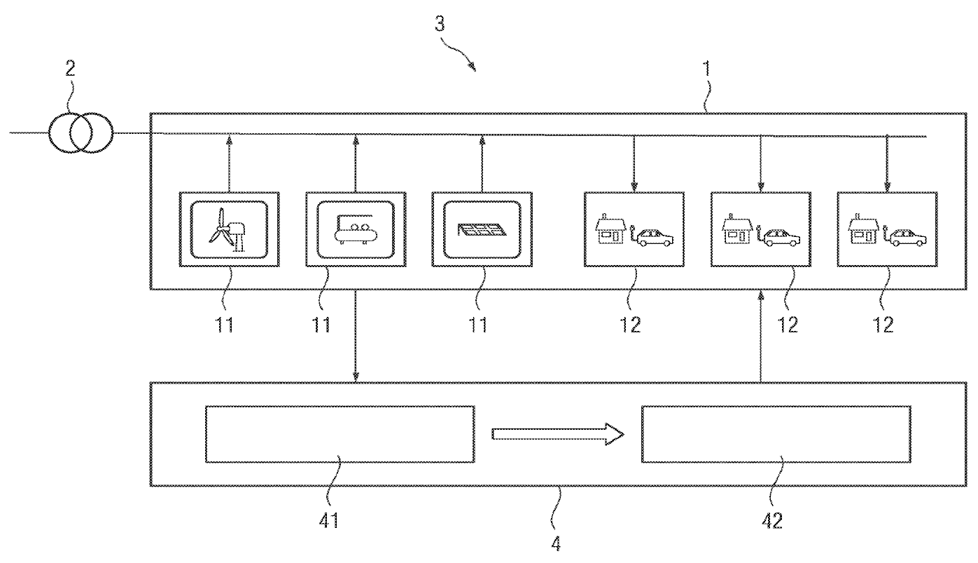

### CROSS-REFERENCE TO RELATED APPLICATIONS

This application is a U.S. National Stage Application of International Application No. PCT/EP2020/085666 filed Dec. 11, 2020, which designates the U.S. of America, and claims priority to DE Application No. 10 2020 203 853.8 filed Mar. 25, 2020, the contents of which are hereby incorporated by reference in their entirety.

### TECHNICAL FIELD

The present disclosure relates to methods for controlling energy conversion, energy storage, energy transportation, and/or energy consumption of multiple energy installations of an energy system, in particular of a building, and/or of multiple consumers of the energy system that are flexible with regard to their load, in particular electric vehicles.

### BACKGROUND

Energy systems, for example districts, communities, or buildings, typically comprise multiple energy installations for energy conversion, energy consumption, and/or energy storage. The conversion, consumption, storage, and transportation of energy should be as efficient as possible. In particular, local energy generation and local energy consumption of multiple energy systems should be correlated with one another as best possible. For this purpose, use is made of mathematical optimizations that are for example performed in a centralized manner by a local energy market with regard to multiple energy systems.

Known local energy markets perform joint optimization for all energy systems involved for each time step. It may be the case here that the local energy market is not able to ascertain a clear optimum solution, but rather multiple solutions are equal. This is the case in particular when the energy system comprises flexible consumers, that is to say consumers that are temporally flexible in particular with regard to their energy consumption. Such a local energy market (energy market platform, trading platform) is described in document EP 3518369 A1.

In particular, respectively similar purchase offers for electricity are transmitted to the local energy market for multiple electric vehicles or for the associated charging stations. If the total costs are used as optimization variable (objective function), then this typically results in multiple equivalent optimization solutions, for example charging all electric vehicles at 15:00 or 18:00. The solutions are therefore economically equivalent. The disadvantage of this is that the solutions are however not technically equivalent. For instance, from a technical point of view, simultaneous charging of all electric vehicles is undesirable, as this may overload the power grid, for example. In other words, the solution that is best from an economic point of view is not necessarily the solution that is most optimum from a technical point of view.

### SUMMARY

The teachings of the present disclosure may provide a solution that is optimum from a technical point of view. For example, some embodiments include a method for controlling energy conversion, energy storage, energy transportation and/or energy consumption of multiple energy installations (11) of an energy system (1), in particular of a building, and/or of multiple consumers (12) of the energy system (1) that are flexible with regard to their load, in particular electric vehicles, based on a mathematical optimization, wherein values of variables provided for the control, in particular of powers of the energy installations (11) and/or of the flexible consumers (12), are calculated by the optimization, characterized in that the optimization is based on a first and second optimization variable, wherein multiple solutions of the values of the variables, which solutions are optimum with regard to the first optimization variable, are calculated by way of a first optimization (41), and one of the calculated solutions that is optimum with regard to the second optimization variable is ascertained as values of the variables for the control by way of a second optimization (42) and used for the control.

In some embodiments, the first and second optimization variable are defined according to a fixed priority.

In some embodiments, a degree of use of an electricity grid, the peak power, generation peaks and/or load peaks, prioritization according to type of load, prioritization according to instability of a load, an availability of one or more energy installations and/or or an emission, in particular a specific carbon dioxide emission and/or a specific nitrogen oxide emission, are/is used as second optimization variable.

In some embodiments, the Pareto principle is used to ascertain the solution that is optimum with regard to the second optimization variable.

In some embodiments, the total amount of energy converted is used as first optimization variable.

In some embodiments, the energy system (1) comprises multiple electric vehicles as flexible consumers (12) within a time range, and the total charging energy within the time range is used as first optimization variable, and the total power is used as second optimization variable, wherein the total charging energy is minimized by way of the first optimization and the total power is minimized by way of the second optimization.

In some embodiments, the first and second optimization (41, 42) are performed by a local energy market platform (4), wherein the local energy market platform (4) transmits a control signal intended for the control to the energy system (1), wherein the control signal is based on the solution that is optimum with regard to the second optimization variable.

In some embodiments, the energy system (1) transmits technical data, in particular with regard to its energy installations (11) and/or with regard to its flexible consumers (12), to the local energy market platform (4) for the first and/or second optimization (41, 42) .

As another example, some embodiments include a device (3), characterized in that the device (3) is designed to perform a method incorporating teachings of the present disclosure.

### BRIEF DESCRIPTION OF THE DRAWINGS

Further advantages, features, and details of the teachings herein will become apparent from the exemplary embodiments described below and with reference to the drawing. The single figure in this case shows a schematic sequence of a control method incorporating teachings of the present disclosure.

### DETAILED DESCRIPTION

In various methods for controlling energy conversion, energy storage, energy transportation and/or energy consumption of multiple energy installations of an energy system, in particular of a building, and/or of multiple consumers of the energy system that are flexible with regard to their load, in particular electric vehicles, values of variables provided for the control, in particular of powers of the energy installations and/or of the flexible consumers, are calculated based on a mathematical optimization. In some embodiments, the optimization is based on a first and second optimization variable, wherein multiple solutions of the values of the variables, which solutions are optimum with regard to the first optimization variable, are calculated by way of a first optimization, and one of the calculated solutions that is optimum with regard to the second optimization variable is ascertained as values of the variables for the control by way of a second optimization and used for the control. In the present case, the term “control” encompasses “regulation”.

From a structural viewpoint, the IPCC Fifth Assessment Report in particular defines an energy system as: “All components related to the generation, conversion, delivery and use of energy.”

The method described herein and/or one of its embodiments and/or one or more functions, features and/or steps of the method or of its embodiments may be at least partially or fully computer-aided.

A mathematical optimization or optimization within the meaning of the present disclosure is a method for minimizing or maximizing an optimization variable, which is referred to as an objective function. The minimization or maximization of the optimization variable is typically extremely complex and may therefore only be carried out numerically. The optimization variable in this case typically characterizes a technical property or a variable of the system, for example the carbon dioxide emissions or the operating costs of an energy system. The optimization variable has technical parameters and variables. The result of the optimization is the values of the variables, yielding an associated optimum value of the optimization variable (objective function value). The variables are typically technical variables, such as for example powers. The parameters are fixed and parameterize the optimization variable specific to the system. The optimization furthermore typically takes place taking into consideration multiple secondary conditions.

In some embodiments, the energy conversion, energy storage, energy transportation and/or energy consumption within the energy system and/or for multiple energy systems at the same time is optimized by way of the optimization. For this purpose, values of variables of the optimization problem that are provided for the control are calculated. By way of example, the ascertained values correspond to specific power values of individual energy installations and/or flexible consumers. In other words, they in this case define the values of the power at which a particular installation is operated at least in a time range, in particular in an upcoming future time range. In this sense, the present invention provides model-predictive control or regulation.

In some embodiments, the optimization, that is to say the ascertaining of optimum values of the technical variables provided for the control, comprises two sub-optimizations, namely the first and second optimization. In this case, the first and second optimization each have an associated optimization variable or objective function.

After performing the first optimization, there are multiple equivalent solutions for the control. In this case, solutions are basically equivalent if they are a solution of the optimization for the same value of the optimization variables. In other words, the solution, that is to say the values of the variables, is not unique. This is the case in particular when the first optimization variable represents an economic optimization variable, such as for example the total costs.

The problem is therefore which of this multiplicity of solutions is a solution that is as optimum as possible from a technical point of view. The embodiments of the teachings of the present disclosure solves this technical problem by performing the second optimization, which is based on the second optimization variable, which is typically different from the first optimization variable and of a technical nature. In other words, one of the solutions of the first optimization is ascertained as the optimum solution from a technical point of view by way of the second optimization, which is in particular downstream of the first optimization.

This results in the advantage that, from the multiplicity of equivalent solutions of the first optimization, one of the solutions is selected as the solution that is likewise optimum from a technical point of view, symbolically according to at least one further technical criterion that is modeled by the second optimization variable. By way of example, when charging electric vehicles, grid boundary conditions of the associated energy system-internal and/or energy system-external power grid are thereby able to be taken into consideration and complied with. In this case, the control according to the invention allows improved grid-friendly charging or improved grid-friendly operation of the energy system.

In some embodiments, provision may be made for further optimizations involving associated optimization variables. This is the case in particular if the second optimization problem likewise has multiple equivalent solutions.

A device incorporating teachings of the present disclosure is designed to perform one or more of the methods incorporating teachings of the present disclosure. In some embodiments, the device comprises a control platform that is designed to perform the first and second optimization. The control platform may bedesigned as a local energy market platform, wherein the energy system and the local energy market platform are coupled at least in order to exchange data or associated information. This results in advantages and/or embodiments of the device that are similar and equivalent to the methods described herein.

In some embodiments, the first and second optimization variable are defined according to a fixed priority. In other words, the objective functions (first and second optimization variable) are sorted according to their priority. A multiple optimization problem (multi-objective) is thus created. In this case, two or more objective functions (optimization variables) are defined and are sorted according to their priority. By way of example, the solutions that are optimum from an economic point of view are ascertained according to the first objective function and are then sorted in accordance with the technical second optimization variable (technical criterion) according to the subordinate second objective function.

In some embodiments, the following technical criteria are conceivable here:
minimizing peak loads;
minimizing generation and load peaks;
maximizing buffers with respect to a selected availability of energy, in particular with regard to electric vehicles;
prioritizing according to type and/or importance of loads, for example slower charge curves for battery storage units;
prioritizing according to instabilities of loads, for example minimizing the simultaneous occurrence of unstable loads so as to ensure the most stable possible operation of the energy system; and/or
minimizing specific emissions, for example with regard to multiple economically equivalent sales offers at different times with different specific emissions, for example grams of carbon dioxide per kilowatt hour, the sale to a load could be prioritized at the time at which the specific emissions are lowest.

In other words, it may be advantageous for a degree of use of an electricity grid, the peak power, generation peaks and/or load peaks, prioritization according to type of load, prioritization according to instability of a load, an availability of one or more energy installations and/or an emission, in particular a specific carbon dioxide emission and/or a specific nitrogen oxide emission, to be used as second optimization variable.

In some embodiments, the second optimization variable may be a technical variable or represents a technically advantageous criterion.

In some embodiments, the Pareto principle is used to ascertain the solution that is optimum with regard to the second optimization variable. In some embodiments, a compromise or a trade-off between the optimization variables is sought (Pareto optima). Using said Pareto optima, a solution that is optimum according to the at least two optimization variables is ascertained and is used for the control. In addition to purely economic criteria of the first optimization variable, for example an overall cost minimum, technical boundary conditions, such as those listed above, may thereby advantageously additionally be taken into consideration.

In some embodiments, the total amount of energy converted is used as first optimization variable. The first optimization variable thereby may likewise characterize a technical criterion, specifically the maximum amount of energy converted, stored, transported, exchanged and/or consumed within a time range. It may be advantageous here to maximize the amount of energy that is converted, that is to say, with regard to a local energy market, the volume or energy volume that is traded.

In some embodiments, the energy system comprises multiple electric vehicles as flexible consumers within a time range, wherein the total charging energy within the time range is used as first optimization variable, and the total power is used as second optimization variable, wherein the total charging energy is minimized by way of the first optimization and the total power is minimized by way of the second optimization. In other words, the total charging energy and the total power may be minimized within the time range. In this case, due to the typically constant fee for the energy consumption through charging, multiple equal solutions arise, wherein the second optimization symbolically selects the solution that has the lowest total power with regard to the multiple solutions of the first optimization.

In some embodiments, multiple electric vehicles are charged simultaneously within the energy system. The electric vehicles may be charged with the rated power P_{Nenn,n,t} within a charging period T in a temporally flexible manner. The total energy Eₜₒₜₐₗ=Σ_{t,n} P_{Nenn,n,t ·} Δtₜ therefore has to be provided within the specified charging period, wherein Δtₜ corresponds to a time step of the charging period T divided into time steps. The consumer is willing to pay a specific fee ωₜ for each kilowatt hour (kWh), for example 15 cents per kilowatt hour. The first optimization is then defined by min (Σ_{t,n}P_{Nenn,n,t} ▪ Δtₜ ▪ ωₜ) under the secondary condition Eₜₒₜₐₗ = Σ_{t,n}P_{Nenn,n,t} ▪ Δtₜ, wherein Σ_{t,n}P_{Nenn,n,t} ▪ Δtₜ ▪ ωₜ is the first optimization variable, in this case the total costs. In this case, this results in multiple equivalent solutions for the first optimization, since the fee ωₜ was considered to be constant.

In some embodiments, the methods avoid the solver of the first optimization problem symbolically selecting an arbitrary one of the solutions, for example charging between the times t = 1 and t = 5. This is the case because, based on the solutions ascertained or calculated by way of the first optimization, a second optimization is performed according to a second optimization variable. By way of example, the second optimization variable is the total load Pₜₒₜₐₗ = Σ_{t,n}P_{Nenn,n,t}, which is to be minimized from a technical point of view, that is to say the second optimization is defined by min (Σ_{t,n}P_{Nenn,n,t}). The second optimization is thus appended to the first optimization. In the second optimization problem or in the second optimization, the solution that is optimum from a technical point of view according to the second optimization problem may also be sought within the optimum solutions that are permissible according to the first optimization problem or first optimization.

In some embodiments, the first and second optimization are performed by a local energy market platform, wherein the local energy market platform transmits a control signal intended for the control to the energy system, wherein the control signal is based on the solution that is optimum with regard to the second optimization variable. In other words, the energy system participates in a local energy market together with other energy systems. In this case, the first and second optimization are carried out centrally by the local energy market platform with regard to the energy systems. The local energy market platform thus ascertains values of the variables, in particular power values, for the energy system, in particular for all participating energy systems, and transmits them to the respective energy system for the control.

The term “control” should be interpreted broadly here. In particular, any measure taken by the local energy market platform that basically has at least a direct or indirect partial effect on the actual energy exchanges should be understood as control by the local energy market platform. By way of example, the energy exchanges are controlled by a data signal that comprises the values of the variables as control data and is transmitted to the respective energy systems by the local energy market platform. The data signal is used for example to switch on, activate, switch off and/or change the operation of energy installations of the one or more energy systems, wherein the actual direct operational control of the installations may in this case be left to the energy system and/or an energy management system of the energy system. The signal from the local energy market platform in this case merely forms the trigger for said operational processes, which then ultimately lead to the energy exchange, that is to say to the energy provision and/or energy consumption.

The signal from the control platform is in particular a price signal, that is to say a data signal that characterizes cost-effective provision and/or cost-effective consumption. By way of example, provision is cost-effective if more energy is to be consumed locally than is provided locally. By way of example, a local combined heat and power plant is switched on by the price signal. Local consumption is particularly cost-effective when more energy is provided locally than is consumed locally. This is the case for example with increased photovoltaic power generation in the afternoon. The energy efficiency of the local energy market is thus likewise improved by the price signal, since the local provision of energy and the local consumption thereof may be correlated in an improved manner and therefore less reserve energy has to be provided and/or used.

In some embodiments, the energy system transmits technical data, in particular with regard to its energy installations and/or with regard to its flexible consumers, to the local energy market platform for the first and/or second optimization. In this case, the technical data may preferably be part of offers to the local energy market platform. The technical data in particular comprise the maximum amount of energy able to be provided, generated and/or stored within a time range with regard to the energy system and/or with regard to its energy installations and/or its flexible consumers.

The figure shows a device 3 and a sequence of a method incorporating teachings of the present disclosure. The exemplary device 3 comprises an energy system 1 and a local energy market platform 4. In this case, the energy system 1 is connected to a power grid 2 (electricity grid) or linked thereto in order to exchange electrical energy.

The energy system 1 comprises multiple energy installations, in particular one or more wind turbines, one or more combined heat and power plants, one or more photovoltaic installations and multiple flexible consumers 12, in particular charging stations or electric vehicles to be charged or that are charging using said charging stations. In some embodiments, the energy system is in particular a residential building and/or an office building.

In some embodiments, the energy system 1 may basically comprise one or more of the following components as energy installations: Electricity generators, cogeneration plants, in particular combined heat and power plants, gas boilers, diesel generators, heat pumps, compression refrigeration machines, absorption refrigeration machines, pumps, district heating networks, energy transfer lines, wind farms or wind turbines, photovoltaic installations, charging stations for electric vehicles, biomass installations, biogas installations, waste incineration plants, industrial installations, conventional power plants and/or the like.

In some embodiments, offers relating to the generation, storage and/or consumption of energy within a time range, in particular for the next 15 minutes, are transmitted to the local energy market platform by the energy system 1 with technical data of the energy systems 11 and/or flexible consumers 12. This is performed for example by an energy management system of the energy system 1 and/or an edge device of the energy system 1 and/or associated energy installations 11 and/or flexible consumers 12.

The local energy market platform 4, based on the transmitted data of all participating energy systems, in particular the energy system 1, carries out a first and second optimization 41, 42. The optimization variable associated with the first optimization 41 is for example the total costs and/or the amount of energy traded, that is to say the trading volume/energy volume. In this case, the first optimization variable, that is to say in this case the amount of energy traded in the time range, is maximized, or the total costs incurred in the time range are minimized. In this case, the variables of the first optimization variable typically have multiple equivalent values.

In other words, the first optimization problem has multiple equivalent solutions (values of the variables). The variables are for example powers of the energy systems within a specific time range. Downstream of the first optimization 41 is the second (technical) optimization 42, by way of which a technical criterion that is characterized by the second optimization variable is optimized. In other words, a solution that is optimum from a technical point of view with regard to the technical second optimization variable is determined from the multiple equivalent solutions of the first optimization 41. The values of the variables that are associated with this optimum solution form the basis of control signals that are transmitted by the local energy market platform 4 to the energy systems, in particular to the energy system 1. The corresponding data exchange between the energy system 1 and the local energy market platform 4 is indicated by arrows in the figure. The energy system 1 or its energy installations 11 and/or its flexible consumers 12 are then operated in accordance with the transmitted and received control signal, which may have been processed, that is to say in accordance with the calculated optimum values, in particular power values, within a particular period, in particular within the next 15 minutes. This advantageously makes it possible to ensure operation of the energy system 1 that is optimum from an economic and technical point of view.

Although the teachings of the present disclosure have been described and illustrated in more detail by way of the exemplary embodiments, the scope of the disclosure is not restricted by the disclosed examples or other variations may be derived therefrom by a person skilled in the art without departing from the scope of protection of the disclosure.

List of reference numerals

| | |
|---|---|
| 1 | Energy system |
| 2 | Power grid |
| 3 | Device |
| 4 | Local energy market platform |
| 11 | Energy installation |
| 12 | Flexible consumers |
| 41 | First optimization |
| 42 | Second optimization |

What is claimed is:

1. A method for controlling energy conversion, energy storage, energy transportation, and/or energy consumption of multiple energy installations of an energy system and/or of multiple consumers flexible with regard to their load, the method comprising:
optimizing values of variables for control by calculation;
wherein the optimization is based on a first optimization variable and a second optimization variable;
calculating multiple solutions of the values, wherein the multiple solutions are optimum with regard to the first optimization variable, by way of a first optimization;
one of the calculated solutions optimum with regard to the second optimization variable as values of the variables for the control by way of a second optimization; and
using the optimum calculcated solution for controling the energy system .

2. The method as claimed in claim 1, wherein the first optimization variable and the second optimization variable are defined according to a fixed priority.

3. The method as claimed in claim 1, wherein the second optimization variable includes a degree of use of an electricity grid, the peak power, generation peaks and/or load peaks, prioritization according to type of load, prioritization according to instability of a load, an availability of one or more energy installations, and/or or an emission.

4. The method as claimed in claim 1, wherein ascertaining the optimum solution includes a calculation based on Pareto Principles.

5. The method as claimed in claim 1, wherein the first optimization variable includes a total amount of energy converted.

6. The method as claimed in claim 1, wherein:
the energy system comprises multiple electric vehicles as flexible consumers within a time range;
the first optimization variable includes the total charging energy within the time range;
the second optimization variable includes minimizing the total power;
the first optimization includes minimizing the total charging energy; and
the second optimization includes minimizing the total power.

7. The method as claimed in claim 1, wherein:
the first optimization and the second optimization are performed by a local energy market platform;
the local energy market platform transmits a control signal intended for the control to the energy system; and
the control signal is based on the optimum solution.

8. The method as claimed in claim 7, wherein the energy system transmits technical data related to energy installations and/or the flexible consumers to the local energy market platform for the first optimization and/or the second optimization.

9. (canceled)
